(19) United States
(12) Patent Application Publication
(10) Pub. No.: US 2010/0191724 A1
(43) Pub. Date: Jul. 29, 2010

(54) METHOD AND SYSTEM TO IDENTIFY PROVIDERS IN WEB DOCUMENTS

(76) Inventors: Mehmet Kivanc Ozonat, Mountain View, CA (US); Donald E. Young, Portland, OR (US); Sven Graupner, Mountain View, CA (US); Sujoy Basu, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/358,418

(22) Filed: Jan. 23, 2009

(51) Int. Cl. G06F 17/30

(52) U.S. Cl. 707/726; 707/E17.108

(57) ABSTRACT

An exemplary embodiment of the present invention provides a method of identifying providers. The method includes obtaining a results document from a search, wherein the results document comprises references to documents that contain a keyword. analyzing the results document to identify a plurality of the references. The method includes accessing each of the documents using the identified references and analyzing each of the accessed documents to determine a probabilistic value that the accessed document is associated with a provide.

### BACKGROUND

The World-Wide Web (or Web) provides numerous search engines for locating Web-based content. Search engines allow users to enter keywords, which can then be used to identify a list of documents such as Web pages. The Web pages are returned by the keyword search as a list of links that are generally sorted by the degree of match to the keywords. The list can also have paid links that are not as closely matched to the keywords, but are given a higher priority based on fees paid to the search engine company.

Search engines are often used by businesses to locate relevant products, such as Websites of providers of goods and/or services. However, the listing of the results by the match to a keyword does not identify whether the Web pages belong to a provider or merely contains a related word. Further, the search results are listed by Web pages. As numerous related Web pages may be in a single domain, e.g., constituting a Website, the results list can have a significant amount of redundancy. Accordingly, a business searcher can spend a significant amount of time accessing the links to identify which links correspond to useful Websites.

### BRIEF DESCRIPTION OF THE DRAWINGS

Certain exemplary embodiments are described in the following detailed description and in reference to the drawings, in which:

FIG. 1 is a block diagram of a computer network in which a client computer system can access a search engine and a number of providers over a Web, in accordance with embodiments of the present invention;

FIG. 2 is a process flow diagram showing a method for identifying providers in accordance with an exemplary embodiment of the present invention;

FIG. 3 is a block diagram showing a system for identifying providers from search results in accordance with an exemplary embodiment of the present invention; and

FIG. 4 is a block diagram showing a tangible, machine-readable medium that stores code adapted to facilitate the booting of a computer system in accordance with an exemplary embodiment of the present invention.

### DETAILED DESCRIPTION OF SPECIFIC EMBODIMENTS

The Web provides a medium to allow individuals and businesses to find providers of numerous goods and services. Generally, search engines can be used to find content that is related to keywords submitted through a Web browser. A Web page, or results document, listing Web pages that are related to the keywords is typically returned. However, search engines do not necessarily make a determination regarding whether the Web pages they find are associated with providers or merely include the submitted key words. As used herein, the term “provider” should be understood to indicate a business that offers goods, services or information about goods and/or services to customers through a Website. Accordingly, the person performing the search may have to manually access each Web page to determine if the page belongs to a provider's Website.

Exemplary embodiments of the present invention can automatically determine whether references returned from a Web search represent providers or merely point to other content. Exemplary techniques use the results from a search that has been performed on the Web by a search engine or a supplier catalog, e.g., a results document containing links to Web pages matching keywords. The Web page links returned by the search engine can be automatically accessed to download the source code from the target Web pages. The source code for these Web pages can then be analyzed by searching for keywords and calculating a probabilistic value for each Web page that classify the Web page as being associated with a provider. Generally, this association means that the provider owns the Web page, but the provider may merely have a presence on the Web page.

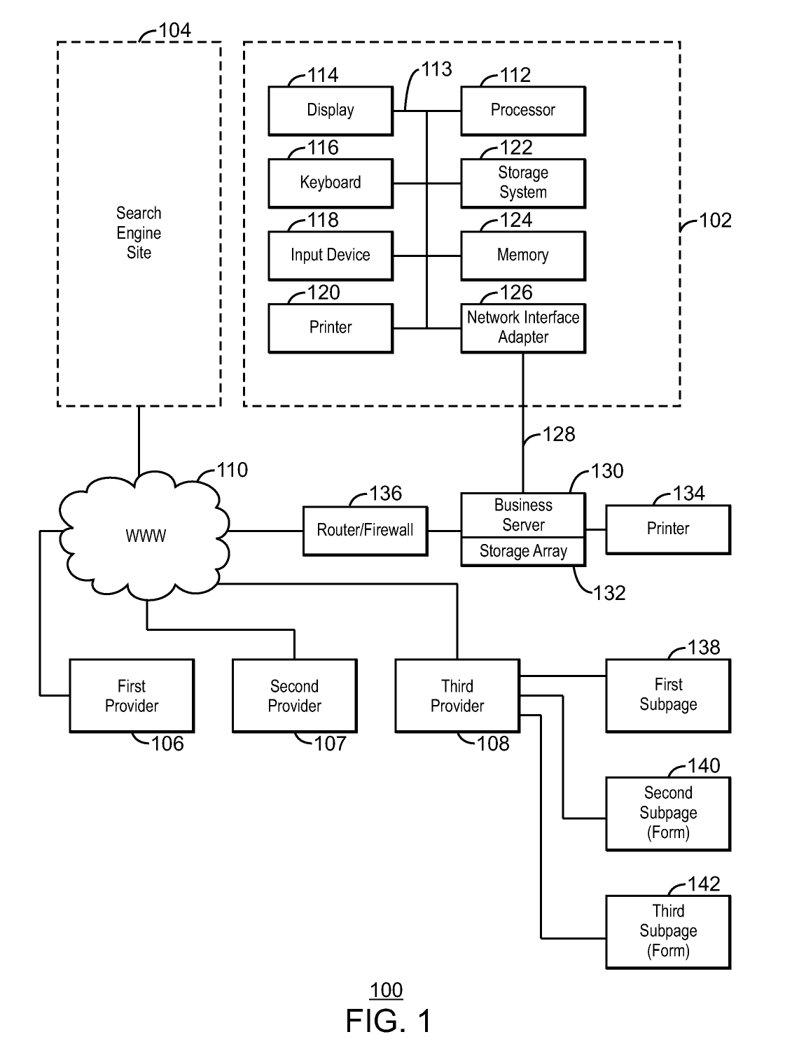

FIG. 1 is a block diagram of a computer network 100 in which a client system 102 can access a search engine 104 and providers 106-108 over the Web 110, in accordance with embodiments of the present invention. As generally illustrated in FIG. 1, the client system 102 can have a processor 112 which is connected through a bus 113 to a display 114, and one or more input devices, such as a keyboard 116 and a pointing device 118. The client system 102 can also have an output device, such as a printer 120 connected to the bus 113.

The client system 102 can also other units operatively coupled to the processor 112 through the bus 113. These units can include tangible, machine-readable storage media, such as a storage system 122 for the long term storage of operating programs and data, such as the programs and data used in embodiments of the present techniques. Further, the client system 102 can have one or more other types of tangible, machine-readable storage media, such as a memory 124, for example, which may comprise read-only memory (ROM) and/or random access memory (RAM). In exemplary embodiments, the client system 102 can also include a network interface adapter 126, for connecting the client system 102 to a network, for example, a local area network (LAN 128), a wide-area network (WAN), or another network configuration. The LAN 128 can include routers, switches, modems, or any other kind of interface device used for interconnection.

Through the LAN 128, the client system 102 can connect to a business server 130. The business server 130 can have a storage array 132 for storing enterprise data, buffering communications, and storing operating programs for the business server 130. The business server 132 can also have associated printers 134, scanners, copiers and the like. The business server 130 can access the Web 110 through a connected router/firewall 136, providing the client system 102 with Web access. The business network discussed above should not be considered limiting. Moreover, those of ordinary skill in the art will appreciate that business networks can be far more complex and can include numerous business servers 130, printers 134, routers 136, and client systems 102, among other units. In other embodiments, the client system 102 can be directly connected to the Web 110 through the network interface adapter 126, or can be connected through a router or firewall 136. Any system that allows the client system 102 to access the Web 110 should be considered to be within the scope of the present techniques.

Through the router/firewall 136, the client system 102 can access a search engine 104 connected to the Web 110. In embodiments of the present invention, the search engine 104 can include generic search engines, such as Altavista.com, Google.com, Yahoo.com, or the like. Further, the search engine 104 can be a business specific catalog site, such as Thompson.net, among others. The client system 102 can also access providers 106-108 through the Web 110. The providers 106-108 can have single Web pages, or as shown for the third provider 108, can have multiple subpages 138-142. The subpages 138-142 can provide information or links, such as the first subpage 138, or can include forms to be filled out by the user, as shown for the second and third subpages 140 and 142.

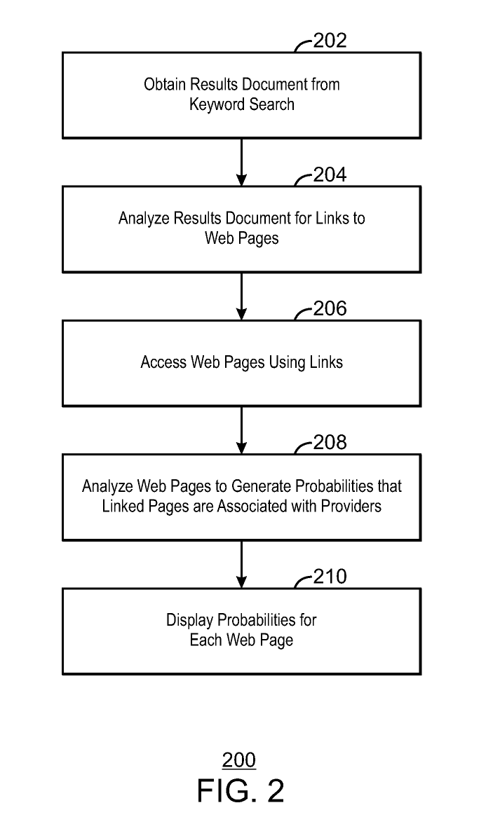

FIG. 2 is a process flow diagram showing a method 200 for automatically identifying providers in accordance with an exemplary embodiment of the present invention. The method 200 begins at block 202 when a results document is obtained in response to the entry of one or more keywords into a search engine by a user. The search engine can be accessed using a Web browser that can be linked to software units, such as add-ons, that can be used to implement the present techniques. A results document returned by the search engine typically comprises a list of Web pages identified by the search. The results generally include links to Web pages that contain the search terms entered by the user.

Web browsers that can be used in embodiments include such products as: Internet Explorer, available from Microsoft; Firefox, available from Mozilla; Chrome, available from Google; Safari, available from Apple; or any number of other Web browsers. The Web browsers and, thus, embodiments of the present invention, can be implemented on any number of computing platforms, including the Macintosh operating system from Apple, the Windows operating system from Microsoft, or Linux based computing platforms, among others.

At block 204, the results document is analyzed to identify links to Web pages. Moreover, source code of the returned results document can be analyzed to identify and store the links to each of the Web pages identified by the search. At block 206, Web pages corresponding to the stored links from the results documents are accessed. For example, the links can be used in command strings, such as HTTP GET commands, or other command strings, to access each of the result pages and obtain the source code of the target page. The source code can then be analyzed to identify indicators that show the likelihood that the page belongs to a provider. The analysis can be performed, for example, by counting the number of indicators present in the source code.

Indicators that the Web page may be associated with a provider can include, for example, keywords that a business Website is likely to use, such as toll-free numbers, requests for credit card information, requests for payment information, requests for contact information, legal notices, the presence of business terminology, or phrases such as “company information”, “jobs”, “career”, or any combinations thereof. Further, indicators can include HTTP tags, such as the “FORM” tag that invites users to supply information such as contact information or the like. The indicators can also be comprised of a combination of keywords and structural information, such as the keywords “credit card” or “Visa” within the structure of html tags such as <form> and <input type=“radio” tags. Indicators can be derived in a number of ways, such as analysis of known service engagement documents, and can be weighted by their significance of indicating a provider.

A Web page may be deemed to belong to a provider if testing indicates that the Web page has a certain number of indicators. If results from a Web page do not contain a sufficient number of indicators that the Web page belongs to a provider, links originating from that Web page that are within the same domain, e.g., http://*.hp.com, can be followed and evaluated. The subsequent pages (or subpages) are then also tested to determine whether they have enough indicators to belong to a provider.

At block 208, a numerical value that indicates the probability that each Web page is associated with a provider is computed. The probability can be calculated from an indicator vector that is created for each Web page listing the indicators present on that Web page, as discussed in further detail herein. The presence of each indicator can be multiplied by a previous defined weight factor for that indicator. The products for all of the indicators can be summed and divided by the number of indicators to provide the value for the probability. Further, a combined indicator vector can be used to profile an entire Website, since some providers scatter their information for the indicators across different pages and forms, such as a first page or form that requests identification of a desired service and a second page or form requesting payment information.

After the probability values are calculated for each Web page, probabilities for each page can be displayed, as shown at block 210. Moreover, the list of links from the results document can be reordered and displayed according to which link has the highest probability of belonging to a provider. In an exemplary embodiment, Web pages that are below a user-selected probability can be dropped from the new listing of links from the results document. Previously low-ranked Web pages can be placed higher in the new results list if the analysis indicates a higher probability that the Web page belongs to a provider. In other embodiments, the original results document may be displayed, with the probabilities displayed in proximity to the links to the Web pages.

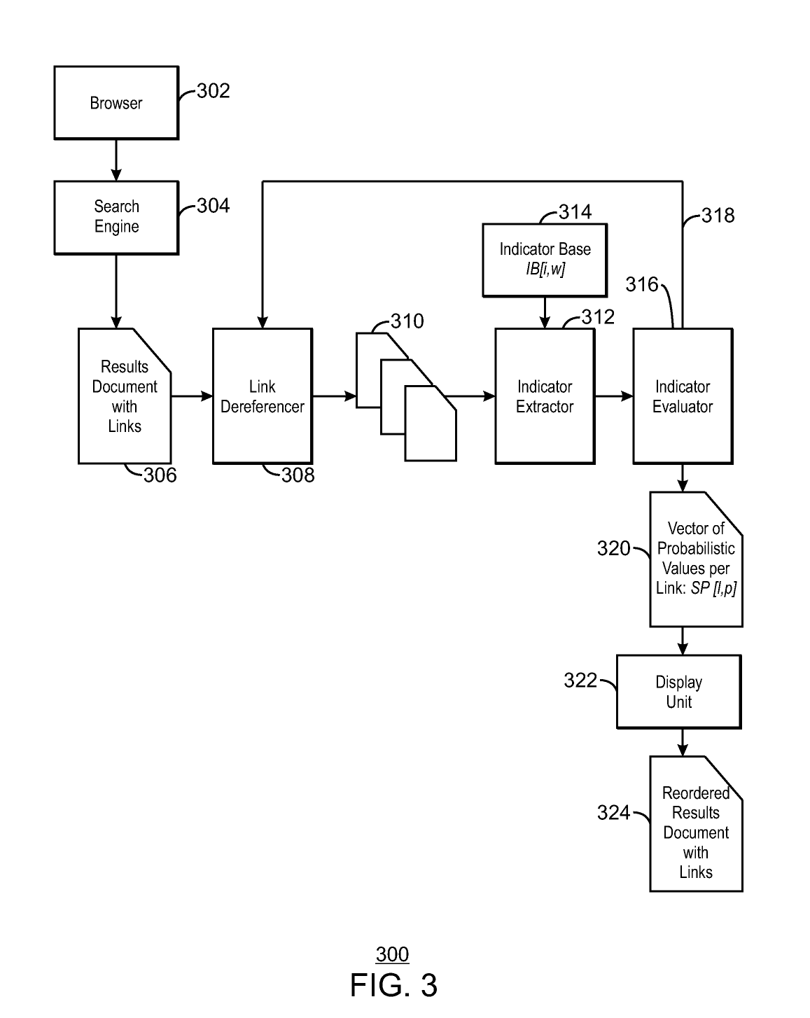

FIG. 3 is a block diagram showing a system 300 for identifying providers from search results in accordance with an exemplary embodiment of the present invention. Those of ordinary skill in the art will appreciate that some of the software components of the system 300 can be stored in and read from a tangible, machine-readable medium, such as the memory 124 or the storage system 122 of the client system 102 shown in FIG. 1. In addition, some of the software components of the system 300 can operate in tangible, machine-readable media, such as memory associated with the business server 130 or the search engine site 104 shown in FIG. 1.

In an exemplary embodiment, a browser 302, generally located on the client computer 102 (FIG. 1), can be used to access a search engine 304. As described herein, the search engine 304 is a service that provides search capabilities for the Web. The search engine 304 accepts keywords provided by the user as input. The search engine 304 then returns a results document 306. For example, the results document 306 can be displayed in the form of a hyper-text markup language (or HTML) page. The results document 306 displays the search results as links pointing to Web pages that match the keywords. Each link can comprise an embedded universal resource locator (or URL) placed in an HTML tag that is associated with text, e.g., <a href=“link_url”>link</a>.

The results document 306 is processed by a link dereferencer 308, which scans source code of the results document 306 for links. The link dereferencer 308 can perform a requested operation, such as an HTTP GET request, to obtain the source code of each Web page 310 that is referenced by a link in the results document 306. Accessing the source code of the Web pages 310 referred to by the link can be termed “dereferencing” the link. Output from the link dereferencer 308 can comprise source code for the set of Web pages 310, each returned from one link.

In an exemplary embodiment, a user can restrict the link dereferencer 308 to obtaining source code for Web pages 310 located in a search results section of the results document 306. In this manner, the link dereferencer 308 can be prevented from obtaining source code for Web pages 310 representing advertising, sponsored links, or other material.

The source code for the Web pages 310 is processed by an indicator extractor 312. The indicator extractor 312 is a software component that is adapted to search the source code of each Web page 310 for the presence of indicators and to collect the indicators into a vector P[]. Moreover, the vector P[] can comprise all of the indicators found on the Web pages 310. The indicator extractor 312 can perform this function by identifying a list of words present in the source code of each Web page 310, then comparing the words to a list of words in an indicator base 314. The indicator base 314 is a data structure of a weighted vector of indicators that, if present in the source code of the Web pages 310, can indicate that the Web pages 310 are associated with a provider. The data structures in the indicator base 314 can be represented as IB[i,w], wherein i represents an indicator description and w represents the weight of the indicator. The indicator base 314 can be readily modified to change the results of the evaluation.

The vector P[] of indicators is submitted to an indicator evaluator 316. The indicator evaluator 316 is a software component that is adapted to compute a decision about whether one or more of the Web pages 310 have sufficient weighted indicators, based on the vector P[], to be classified as being associated with a provider. The indicator evaluator 316 can perform a further dereferencing cycle to follow links contained in the Web page 310 being evaluated, as indicated by an arrow 318. For example, if one or more of the evaluated Web pages 310 do not have sufficient indicators to make a determination, the links on the Web page 310 that are within the same URL domain can be tested. The dereferencing recursion can be halted after the content of the URL domain can be sufficiently classified as likely to be associated with a provider or not. Alternatively, the recursion can be halted after a predetermined number of dereferencing cycles or after all of the Web pages in a domain, e.g., an entire Website, have been evaluated.

The indicator evaluator 316 generates a vector 320 of probabilistic values p for each link I, SP[I,p], which can indicate the likelihood of the link pointing to a Web page 310 that is associated with a provider. A value of 1.0 can indicate a high likelihood that one or more of the Web pages 310 is associated with a provider, while a value of 0 can indicates a high likelihood that none of the Web pages 310 is associated with a provider. Accordingly, values between 0.0 and 1.0 can indicate a proportional likelihood that at least one of the Web pages 310 is associated with a provider. Further, if the indicator evaluator 316 has recursively accessed other pages linked to the Web page 310 being evaluated, the vector 320 can represent the probability that an entire Website is associated with a provider.

The vector 320 can be directly displayed or can be provided to a display unit 322. The display unit 322 can display a new results document 324 showing the results ordered by the probabilistic values, for example, from highest to lowest. The new results document 324 can omit any results that have a probabilistic value lower than a user-defined limit, for example, less than about 0.1, 0.2, 0.3, 0.5, or any other value that appropriately limits the results. Further, the new results document 324 can have items corresponding to entire Websites, for example, when the indicator evaluator 316 has recursively accessed several Web pages 310 from a single domain. The display unit 322 is not limited to displaying results as an ordered list. For example, the display unit 322 can display the initial results document 306 with the probabilistic value for each of the Web pages 310 displayed in proximity to the link for that page.

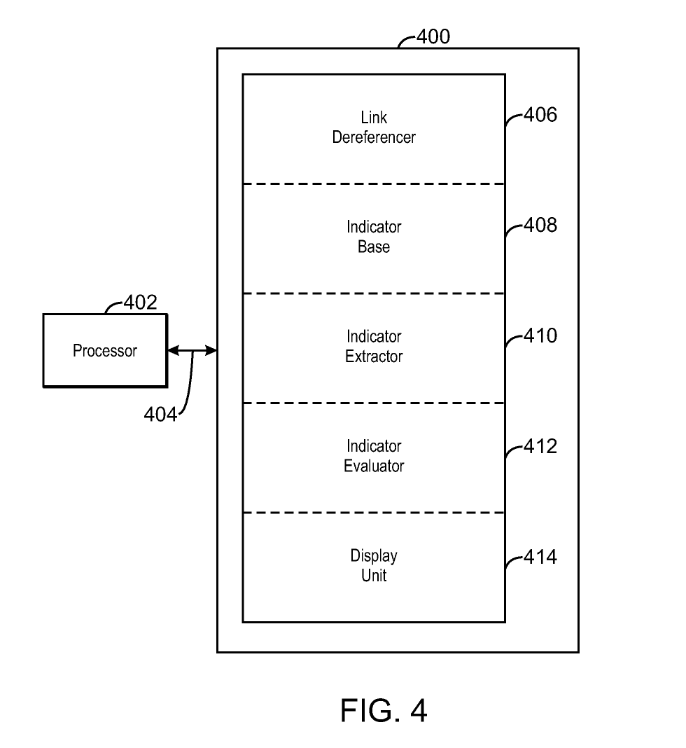

FIG. 4 is a block diagram showing a tangible, machine-readable medium that stores code adapted to facilitate the booting of a computer system in accordance with an exemplary embodiment of the present invention. The tangible, machine-readable medium is generally referred to by the reference number 400. The tangible, machine-readable medium 400 can comprise RAM, one or more hard disk drives, a non-volatile memory, a USB drive, a DVD, a CD or the like. In one exemplary embodiment of the present invention, the tangible, machine-readable medium 400 can be accessed by a processor 402 over a computer bus 404 within a client system.

The various software components discussed herein can be stored onto the tangible, machine-readable medium 400 as indicated in FIG. 4. For example, the link dereferencer can be stored in a first block 406 on the tangible, machine-readable medium 400. A second block 408 can include the indicator base. A third block 410 can include the indicator extractor. A fourth block 412 can include the indicator evaluator. Finally, a fifth block 414 can include the display unit. Although shown as contiguous blocks on the tangible, machine-readable medium 400, the software components 406-414 can be stored in any order or configuration. For example, if the tangible, machine-readable medium 400 is a hard drive, the software components can be stored in non-contiguous, or even overlapping, sectors.

### EXAMPLE

An exemplary embodiment of the present invention was tested to determine the efficacy of the techniques. In this embodiment, the presence of FORM pages and the accompanying requests for client information, were used as indicators that Web pages could belong to providers. Specifically, the indicator base (IB[I,w]) used for the test is shown in columns 2 (i) and 3 (w) of Table 1.

The information in Table 1 was assembled by examining the Web pages from a number of providers. It was discovered that choosing indicators where the site asks for information from the client was an effective way of narrowing down sites that might be owned by providers. The weights for each dimension (w), as shown in column 3 were then established. For example, many Web pages have forms for searching and many businesses have toll free numbers so they are not, by themselves, clear indicators of a provider. Accordingly, the weight of these indicators was reduced to 0.6 in this example.

As can be seen by weighting factor (w) used in row 16, the weighting factors are not limited to positive values. Thus, a negative weighting factor can be used to account for the occurrence of items that militate against the Web page belonging to a provider. If there is a particularly important negative characteristic such as a long table of similar entries likely found in a directory of services but not the provider itself (it is a directory service), then one can assign a high negative weight to reject such Web pages.

An example Web page was analyzed using the information in Table 1. A comparison of the source code for the Web page with the indicators shown in column 2 resulted in the true/false indication shown in column 4, which is 1 if the indicator was present and 0 if the indicator was not present. Many variants are possible, for example, the number of times an indicator appears in a Web page could be used in place of the true/false indication.

TABLE 1
Example of weighted term occurrence for a printing service

| | | | i: to what | |
|---|---|---|---|---|
| | | w: weight | extent | |
| | Vector Dimension | (0 to 1) | present | w * i |
| 1 | Form present | 0.6 | 1 | 0.6 |
| 2 | Payment information | 1 | 1 | 1 |
| | requested | | | |
| 3 | Toll free number | 0.6 | 1 | 0.6 |
| 4 | <select HTML tag | 1 | 1 | 1 |
| | indicating a user is | | | |
| | asked to make a | | | |
| | selection | | | |
| 5 | Contact information | 1 | 1 | 1 |
| | requested | | | |
| 6 | Keyword #1 | 1 | 1 | 1 |
| | “billing” | | | |
| 7 | Keyword #2 | 1 | 1 | 1 |
| | “contact” | | | |
| 8 | Keyword #3 | 1 | 1 | 1 |
| | “payment” | | | |
| 9 | Keyword #4 | 1 | 1 | 1 |
| | “visa” | | | |
| 10 | Keyword #5 | 1 | 1 | 1 |
| | “order” | | | |
| 11 | Keyword #6 | 1 | 1 | 1 |
| | “price” | | | |
| 12 | Keyword #7 | 1 | 1 | 1 |
| | “customer” | | | |
| 13 | Keyword #8 | 0.6 | 0 | 0 |
| | “SOA” | | | |
| 14 | Keyword #9 | 1 | 0 | 0 |
| | “api” | | | |
| 15 | Keyword #10 | 1 | 0 | 0 |
| | “interface” | | | |
| 16 | A long table of similar | −1 | 0 | 0 |
| | entries indicating it can | | | |
| | be a directory of | | | |
| | services | | | |
| 17 | Total | | | 11.20 |
| 18 | Normalized to number | | | 0.7 |
| | of dimensions used | | | |

The true/false indication in column 4 was multiplied by the weight in column 3, resulting in the values shown in column 5. These values were summed, providing the value of 11.20 in row 17, and normalized by the number of dimensions, providing the value of 0.7 in row 18. An upper threshold may be set to indicate the association of the Web page with a provider, for example, 0.6 in the present example. As the normalized value, 0.7, is above this threshold the Web page is likely to be associated with a provider.

A lower threshold may be set to indicate if a Website is likely not associated with a provider, for example, 0.1. If the normalized sum is between those values, then the indicator evaluator may keep crawling that domain to get a clearer indication, e.g., above the higher threshold or below the lower threshold. The weights and thresholds could be set by analyzing the sites of desired types of known providers and known non-providers. More complex algorithms may also be defined.

What is claimed is:

1. A method of identifying providers, comprising:
obtaining a results document from a search, wherein the results document comprises references to documents that contain a keyword;
analyzing the results document to identify a plurality of the references;
accessing the documents that correspond to the identified references; and
analyzing each of the accessed documents to determine a probabilistic value that the accessed document is associated with a provider.

2. The method of claim 1, comprising displaying a revised results document on the display screen, wherein the references are ordered by the probabilistic values.

3. The method of claim 1, wherein the documents comprise Web pages.

4. The method of claim 1, wherein the references comprise links to Web pages.

5. The method of claim 1, wherein obtaining the results document comprises:
submitting the keyword to a search engine;
obtaining a Web page from the search engine comprising the references, and
storing a source code for the Web page from the search engine as the results document.

6. The method of claim 5, wherein analyzing the results document comprises:
identifying the plurality of the references in the results document based on format and content; and
storing each of the identified references in a table entry.

7. The method of claim 1, wherein accessing the documents comprises:
forming a command string with each of the identified references;
issuing the command string to access the document; and
storing a source code for the accessed document in a local memory for analysis.

8. The method of claim 7, comprising:
analyzing the source code for references to subpages;
accessing the subpages that are within the same domain; and
storing a source code for each of the subpages in a local memory for analysis.

9. The method of claim 8, comprising:
analyzing each of the accessed subpages to calculate a probabilistic value that the accessed subpage is associated with a service provider; and
generating a combined probabilistic value that the domain is associated with a provider.

10. The method of claim 1, wherein analyzing each of the accessed documents comprises:
searching a source code for the accessed document for indicators, wherein each of the indicators provides a probability that the accessed document is associated with a provider.

11. The method of claim 10, wherein the indicators comprise keywords, wherein the keywords comprise toll-free numbers, “company information”, “jobs”, “career”, requests for credit card information, requests for payment information, requests for contact information, legal notices, or the presence of business terminology, or any combinations thereof.

12. The method of claim 10, wherein the indicators comprise hyper-text markup language (html) tags indicating forms.

13. The method of claim 1, comprising displaying a results document that orders the identified references by the probabilistic value for each accessed document.

14. A computer system for identifying providers, comprising:
a processor that is adapted to execute stored instructions;
a memory device that stores instructions that are executable by the processor, the instructions comprising:
a Web browser configured to access Web pages over the network interface;
a link dereferencer configured to obtain a source code for each of a plurality of the Web pages in a source document;
an indicator extractor configured to analyze the source code for each of the Web pages; and
an indicator evaluator configured to calculate a probability that each Web page is associated with a provider.

15. The system of claim 14, wherein the link dereferencer is configured to analyze the source document for links to Web pages, access each of the Web pages, and store the source code for each of the Web pages in a memory.

16. The system of claim 14, wherein the indicator extractor is configured to analyze the source code for each of the Web pages for indicators that the Web page is associated with a provider.

17. The system of claim 14, wherein the indicator evaluator is configured to compare the indicators to indicators that are stored in the memory device, and calculate a probability that the Web page is associated with a provider.

18. The system of claim 14, comprising a display unit configured to generate an updated results document listing each of the Web pages in order by the probability.

19. A tangible, computer-readable medium, comprising:
code configured to accept keywords from an input device, access a search site over a network interface, and display a results document on a display;
code configured to analyze the results document to identify a plurality of links to Web pages, access the Web pages using the identified links, and store a source code for each of the accessed Web pages in a memory;
code configured to analyze the source code for each accessed Web page for indicators that the accessed Web page is associated with a provider; and
code configured to compare the indicators to probabilistic values for each indicator that are stored in the storage device, and calculate a probability that the accessed Web page is associated with a provider.

20. The tangible, computer-readable medium of claim 19, comprising:
code configured to display the probability for each accessed Web page on the display.
